(19) United States
(12) Patent Application Publication
(10) Pub. No.: US 2025/0313059 A1
(43) Pub. Date: Oct. 9, 2025

(54) VENT FAN AND RELATED METHODS

(71) Applicant: Freedom Fans LLC, Cincinnati, OH (US)

(72) Inventor: Stephen Thomas Recktenwald, Buffalo, NY (US)

(21) Appl. No.: 19/094,118

(22) Filed: Mar. 28, 2025

Related U.S. Application Data
(60) Provisional application No. 63/574,314, filed on Apr. 4, 2024.

(51) Int. Cl. B60H 1/00; B60H 1/24; B60H 1/26

(52) U.S. Cl. CPC B60H 1/00471; B60H 1/245; B60H 1/262

(57) ABSTRACT

A vent fan and related methods includes a frame surrounding an opening, a lid, and a first fan. The frame includes a cavity, an upper port fluidly connecting the cavity to the opening, and a lower port fluidly connecting the cavity to the opening. The lid is operatively connected to the frame and configured to selectively move from a closed position toward an open position. In the closed position, the lid covers the opening. In the open position, the lid allows an airflow through the opening. The first fan is positioned within the cavity and configured to direct the airflow between the upper port and the lower port for venting the airflow.

### CROSS-REFERENCE TO RELATED APPLICATION

This application claims priority to U.S. Pat. App. No. 63/574,314 filed on Apr. 4, 2024 entitled “Vent Fan and Related Methods,” the disclosure of which is hereby incorporated by reference herein, in its entirety.

### BACKGROUND

Vehicles include at least partially-sealed interior spaces which can become subject to extreme temperature ranges, humidity/moisture, odors, dust, pollen, and cooking and other fumes because of lack of ventilation with the surrounding exterior. These vehicles can be used for various types of activities including user occupancy where it can be preferable to avoid such extreme temperature ranges. These vehicles may be subject to these temperatures especially while the vehicle is not running and thus while the vehicle's heating and cooling systems are not operable. Passively venting these vehicles is often useful for preventing these extreme ranges and, moreover, actively venting to move air between an exterior and interior of the vehicle can be used to rapidly bring temperatures to a more comfortable temperature for the occupant.

While several fan assemblies and methods have been used, it is believed that no one prior to the inventor has made or used the invention described, illustrated and claimed herein.

### BRIEF DESCRIPTION OF THE DRAWINGS

FIG. 1 depicts a perspective view of a vehicle having a fan assembly;

FIG. 2 depicts a perspective view of the fan assembly of FIG. 1 with a lid in an open position, the lid including a lid cover;

FIG. 3 depicts a perspective view of the fan assembly of FIG. 1 with the lid of FIG. 2 in a closed position, the lid excluding the lid cover;

FIG. 4 depicts an exploded perspective view of the fan assembly of FIG. 1;

FIG. 5 depicts a sectional, perspective view of the fan assembly of FIG. 1, taken along section line 5-5 of FIG. 3;

FIG. 6 depicts a cross-sectional view of the fan assembly of FIG. 1, taken along section line 5-5 of FIG. 3;

FIG. 7 depicts an enlarged cross-sectional view of the fan assembly of FIG. 6, having at least an inner fan hidden for clarity;

FIG. 8 depicts a perspective view of an exemplary motor and fan of the fan assembly of FIG. 1;

FIG. 9 depicts a cross-sectional view of the fan of FIG. 8, taken along section line 9-9 of FIG. 8;

FIG. 10A depicts an enlarged, sectional view of the vent fan of FIG. 1 directing airflow from the interior of the vehicle, through an opening, and toward an environment exterior of the vehicle;

FIG. 10B depicts an enlarged, sectional view of the vent fan of FIG. 1 directing airflow from the environment exterior of the vehicle, through the opening, and into the interior of the vehicle;

FIG. 11A depicts an enlarged, sectional view of an alternative vent fan including baffles directing airflow from the interior of the vehicle, through an opening, and toward an environment exterior of the vehicle; and

FIG. 11B depicts an enlarged, sectional view of the alternative vent fan of FIG. 11A including the baffles directing airflow from the environment exterior of the vehicle, through the opening, and into the interior of the vehicle.

### DETAILED DESCRIPTION

The following description of certain examples of the invention should not be used to limit the scope of the present invention. The drawings, which are not necessarily to scale, depict selected embodiments and are not intended to limit the scope of the invention. The detailed description illustrates by way of example, not by way of limitation, the principles of the invention. Other examples, features, aspects, embodiments, and advantages of the invention will become apparent to those skilled in the art from the following description, which is by way of illustration, one of the best modes contemplated for carrying out the invention. As will be realized, the invention is capable of other different or equivalent aspects, all without departing from the invention. Accordingly, the drawings and descriptions should be regarded as illustrative in nature and not restrictive.

Any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those skilled in the art in view of the teachings herein. Such modifications and variations are intended to be included within the scope of the claims.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±10% of the recited value, e.g. “about 90%” may refer to the range of values from 81% to 99%. In addition, as used herein, the terms “patient,” “host,” “user,” and “subject” refer to any human or animal subject and are not intended to limit the systems or methods to human use, although use of the subject invention in a human patient represents a preferred embodiment.

### I. Overview of an Example Fan Assembly

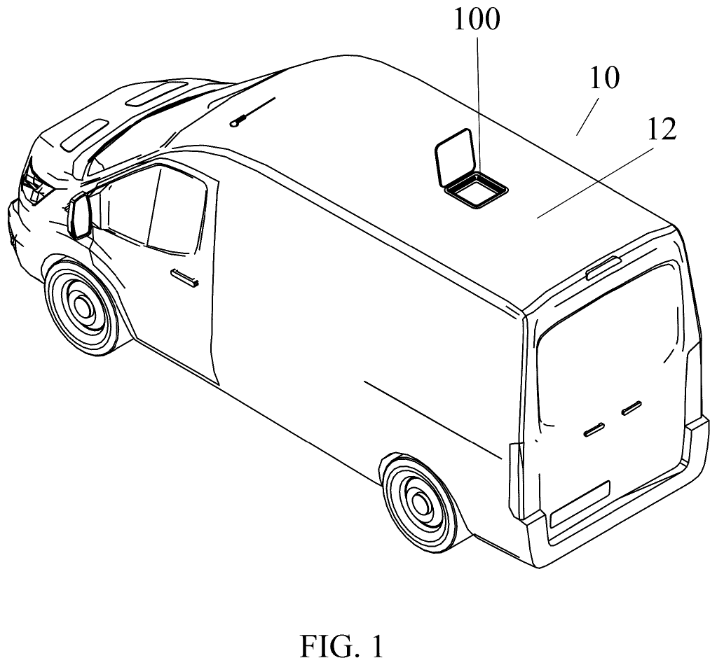

FIG. 1 shows a vehicle (10) having a roof (12) with a fan assembly (100) (also referred to as a fan apparatus) mounted thereto. Vehicle (10) may include a spacious interior suitable for extended travel/stay, sleeping, cooking, and camping such as minivans, cargo vans, sprinter vans, recreational vehicles (RV), motorcoaches, trailer homes, pull-behind campers, motorhomes, campers, trailers, pop-ups, camper vans, skoolies, car campers, custom converted vehicles, ambulances, fire trucks, food trucks, ground control vehicles, surveillance vehicles, cargo vehicles, trailers, buses, boats, etc.

Fan assembly (100) is used to ventilate the interior of vehicle (10) by passively and actively moving air from outside of vehicle (10) into the interior or by moving air from the interior towards the outside of vehicle (10). This air movement will be described in greater detail below. Fan assembly (100) may be mounted to a flat surface or panel such as roof (12). While fan assembly (100) is shown and described as being used in a mobile vehicle (10) setting, this is a non-exhaustive list of applications and fan assembly (100) may instead be mounted and used in nearly any situation where ventilation is desired. Non-exhaustive applications also include residential buildings, commercial buildings, greenhouses, car sunroofs, truck caps, mobile offices/stores, storage containers, tiny homes, and tents. As an alternative to mounting fan assembly (100) to roof (12), fan assembly (100) may be mounted to any portion of vehicle where ventilation is desirable, such as on a side, on a back end, underneath, and on a front of vehicle (10). In other words, any area benefiting from ventilation, pass through, and/or an unobstructed view to an exterior environment may incorporate such fan assembly (100) therein. The fan assembly (100) allows for active airflow (both into and out of a space, such as within an interior) while also being a skylight and roof hatch with unimpeded views therethrough. Benefits of a skylight include natural light, makes a space feel more open by having overhead area visibly open to the exterior environment, stargazing, privacy (less likely for people to see in as compared to a wall mounted window), passively bringing in fresh air, and additional head room. Benefits of a roof hatch of size permitting climb through include means of egress and ingress between exterior environment and interior, emergency exit, maintenance/inspection, and access to rooftop which may poses a deck, cargo, storage, equipment, and/or solar panels which may requiring cleaning.

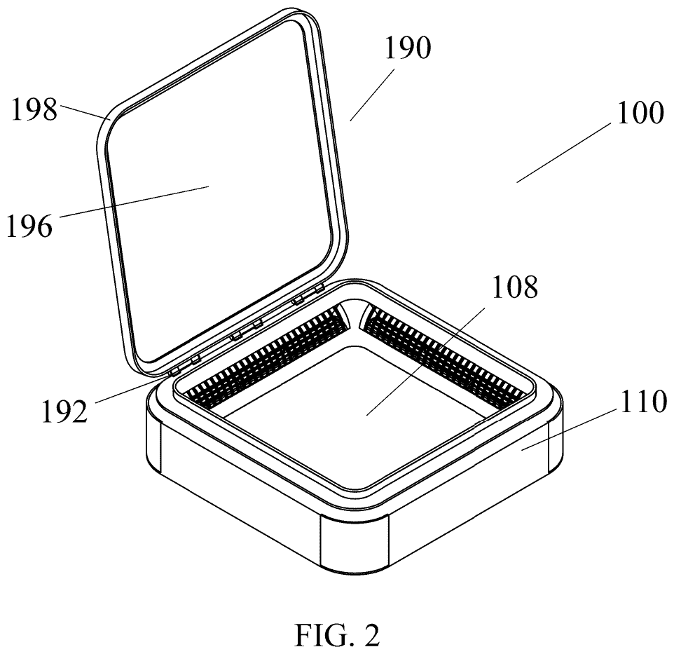

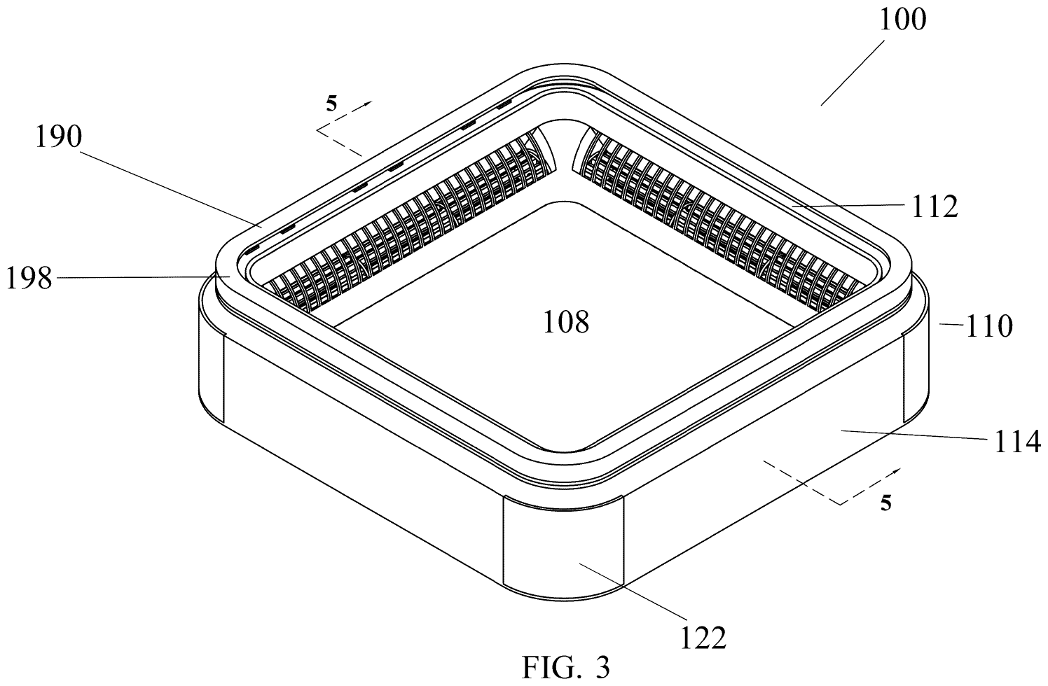

FIG. 2 shows fan assembly (100) including a frame (110) defining an opening (108) and a lid (190) affixed to frame (110) via a lid hinge (192). Opening (108) may be sufficiently sized to allow for egress of a user during an emergency or for roof (12) access. As will be described below, lid (190) selectively transitions between an open position and a closed position by pivoting from lid hinge (192). Lid (190) is shown in the open position in FIG. 2 where opening (108) is exposed and unobstructed. As will be shown in greater detail, lid (190) includes a lid cover (196) affixed to a lid ring (198). FIG. 3 shows lid (190) in the closed position but with lid cover (196) excluded for clarity. Lid (190) may be opaque, translucent, or transparent and may be made of metal or plastic such as acrylic or polycarbonate. When translucent or transparent, lid in the closed position is capable of shining light (such as sunlight) through opening to thereby illuminate the interior space of vehicle (10). When given a translucent or transparent lid, a separate light shield (not shown) may be selectively affixed to fan assembly (100) to thereby block light from entering interior space of vehicle (10).

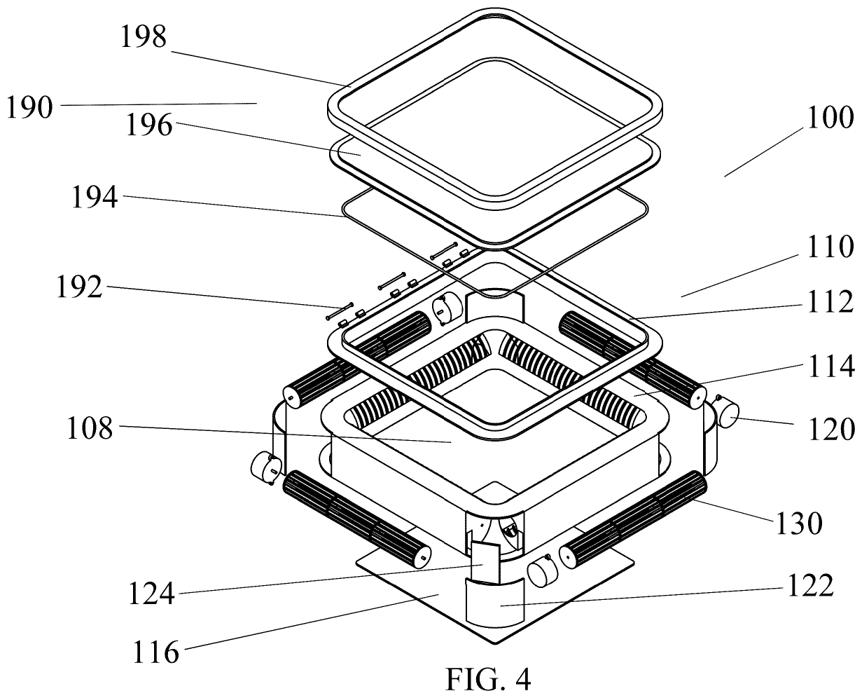

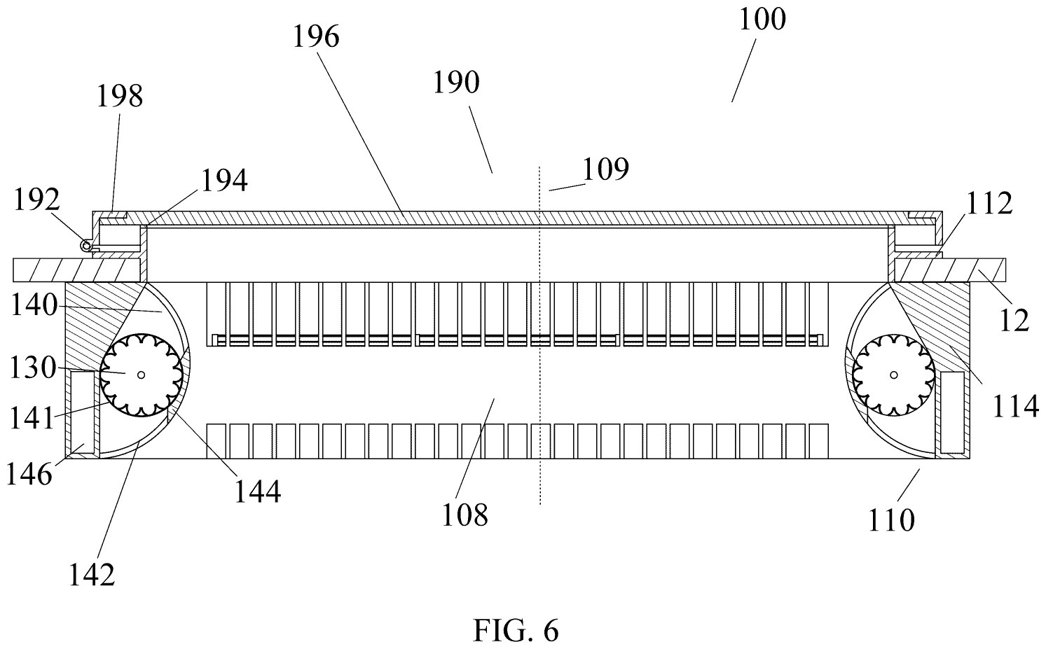

FIG. 4 shows fan assembly (100) including frame (110), a screen (116), a motor (120), a processor (124), a fan (130), and the lid (190). Frame (110) includes an upper frame (112) affixed to a lower frame (114). Roof (12) is sandwiched between portions of upper frame (112) and lower frame (114) to thereby affix fan assembly (100) to vehicle (10). Lower frame (114) is shaped similar to a square having 4 straight portions. In each straight portion is a cavity (141) (see FIG. 6) used to house a respective motor (120) and fan (130) for moving air. Lower frame (114) also includes at least one processor (124) used to drive each of the motors (120).

Upper frame (112) incorporates a portion of lid hinge (192) such that lid (190) is mountable outside of vehicle (10). Upper frame (112) may be mountable to lower frame (114) via adhesive or fixation device. Fan assembly (100) may be mounted to vehicle (10) after an initial production of vehicle (10) such that lower frame (114) and upper frame (112) are affixed while simultaneously sandwiching roof (12). Upper frame (112) includes a gasket (194) which may alternatively be affixed to lid (190). Gasket (194) seals opening (108) from outside of vehicle (10) when lid (190) is in the closed position. When in motion, vehicle (10) may force rainwater laterally against fan assembly (100). Gasket (194) is useful to prevent this rainwater from entering opening (108) and interior of vehicle (10).

Screen (116) is selectively mounted to a bottom of lower frame (114) and is useful as a filter to prevent objects outside of vehicle (10), such as insects, from entering the interior space of vehicle (10) while still allowing airflow and light to pass through opening (108). Such objects may be bugs and dust. Screen (116) may be made of cloth, plastic, or metal such as stainless steel and reusable and cleanable. Screen (116) may be mounted to lower frame (114) through use of a latch, a slot, a roller mechanism, hook-and-loop fastener, or a magnet. Screen (116) may be opaque or tinted to thereby block light coming through lid (190). Multiple screens (116) on a single fan assembly (100) may be used to achieve different functions, such as two separate screens for preventing ingress of outside objects and blocking of light.

Processor (124) may be a single processor (124) or multiple processors (124) throughout fan assembly (100). Processor (124) acts as a power supply to drive motor (120) in either or both of a forward direction and a backwards direction, as will be described later. Processor (124) is in electrical communication with vehicle (10) power supply and may be operable on a 5, 6, 12, 24, and 48 volt input voltage to thereby drive motor (120). Processor (124) is operable to drive each motor (120) independent of any other motor (120). In other words, processor (124) may drive a first motor (120) in the first direction at a first speed, a second motor (120) in the first direction at a second speed, a third motor (120) in the second direction at the first speed, and a fourth motor (120) in the second direction at the second speed. Processor (124) may include a temperature sensor (not shown) capable of determining a temperature of interior of vehicle (10). If interior temperature rises above a predetermined threshold, processor (124) may turn on motor (120) to thereby vent interior of vehicle (10) and thus lower the temperature. Processor (124) may also be programmable to run motor (120) until a predetermined temperature threshold has been reached. The predetermined temperature threshold may be variable and thus input by a user. Processor (124) may include a feedback portion operable to allow a user to determine the predetermined temperature threshold. Processor (124) includes a Bluetooth® module for remotely programming settings of fan assembly (100) such as the predetermined temperature threshold and controlling fan assembly (100). Additionally or alternatively, processor (124) can be controlled via remote, knob, LCD screen, device application, or other control device or communication network. Processor (124) may be integrated into other components such as motor (120).

Processor (124) also includes or is in communication with a humidity and/or rain sensor (not shown). In certain embodiments, processor (124) is operable to detect humidity rising above a predetermined threshold or if rain is present and thus automatically transition lid (190) from the open position to the closed position to thereby prevent rainwater from entering interior of vehicle (10). Alternatively, if humidity inside of vehicle (10) is detected to be higher than a predetermined threshold and the humidity outside vehicle (10) is lower than inside vehicle (10), the lid (190) may be opened for passive and/or active ventilation. Processor (124) may also include or be in communication with a smoke, carbon monoxide, and/or radon sensor (not shown). In certain embodiments, processor (124) is operable to detect smoke, carbon monoxide, and/or radon rising above a predetermined threshold thus automatically transition lid (190) from the closed position to the open position or from a partially open position to a more fully open position for passive and/or active ventilation of vehicle (10). Processor (124) may also include and/or be in communication with a speaker (not shown) operable to warn a user of elevated smoke, carbon monoxide, and/or radon.

In certain embodiments, processor (124) is in communication with a proximity sensor (not shown) to thereby detect foreign object movement near fan assembly. If detected object movement rises above a predetermined threshold, processor (124) may be operable to transition lid (190) from the open position to the closed position to thereby prevent entrance of the object into interior of vehicle (10). In certain embodiments, fan assembly (100) may include a lid driver (not shown) such as a motor, operable to electrically transition lid (190) between the closed and open positions. As yet another feature, fan assembly (100) may be capable of venting opening (108) such that lid (190) raises to be away from lower frame (114) to thus allow airflow through opening (108) while also covering opening (108) from direct light and rain. Additionally or alternatively, a rain guard or shield may be added to fan assembly (100) to allow for airflow through opening (108) while covering opening (108) from rain.

Motor (120) and fan (130) are covered on axial ends by motor cover (122) mounted to lower frame (114). Motor covers (122) are selectively mounted to lower frame (114) to thereby expose motor (120), processor (124), and fan (130) for cleaning, maintenance, and repair without requiring removal of fan assembly (100) from roof (12). With motor cover (122) removed, fan (130) may then also be removed from lower frame (114) for cleaning of fan (130) and lower frame (114).

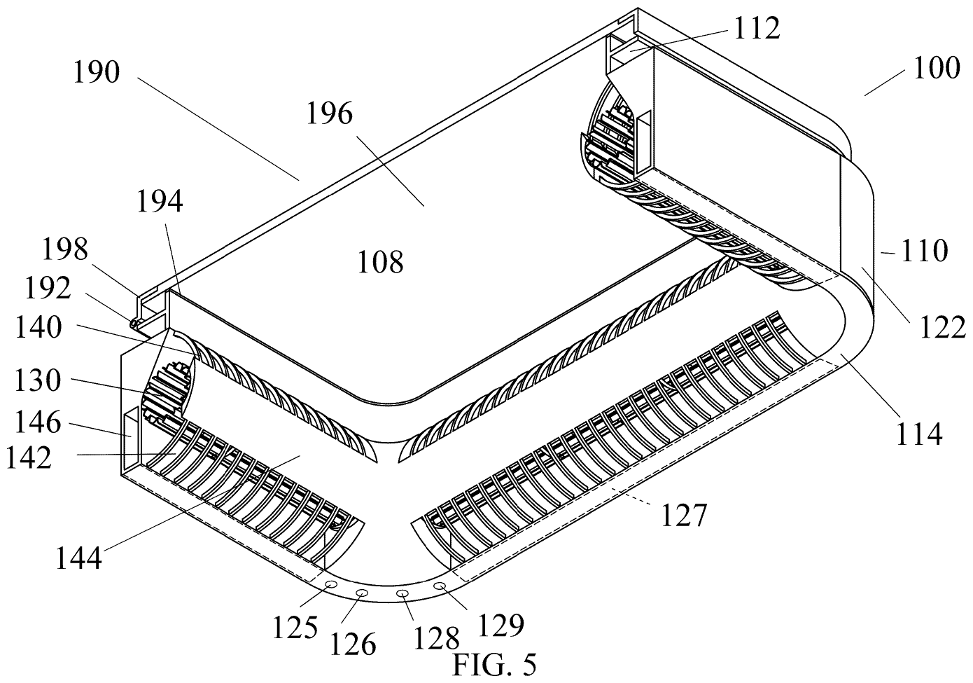

FIGS. 5 and 6 show cross sections of fan assembly (100) taken about line 5-5 of FIG. 3 while mounted to roof (12) (FIG. 6) and including lid cover (196). Fan assembly (100) is shown in the closed position such that gasket (194) is shown sandwiched between upper frame (112) and lid cover (196). Fan assembly (100) further includes a light switch (126) and light (128) positioned along a lower surface of lower frame (114). Light switch (126) may be in electrical communication with processor (124) or may be wired directly in series with light (128). In either case, light switch (126) is operable to power light (128) to thereby illuminate the interior space of vehicle (10). Light switch (126) may include an on-off position to transition light (128) between an on output and an off (zero) output or may be operable to selectively transition light (128) between a desired light output between and including full on and zero output. Alternative light locations (127) for light (128) are shown around the underside of lower frame (114). Single or multiple lights (128) may be used.

Fan assembly (100) may also include a fan switch (125) operable to rotate fan (130) in either rotational direction. In situations where there is a low desired airflow and multiple fans (130), fan switch (125) may be operable to activate only one or less than all of the fans (130) to achieve the desired reduced airflow. Switches (125, 126) may be momentary switch, a maintained switch, or a potentiometer. While switches (125, 126) are shown incorporated into lower frame (114), they may alternatively or additionally be mounted to vehicle (10), such as to a dash (not shown) or of a different configuration such as a remote, LCD screen, or device application. Fan assembly (100) may further include an ambient light sensor (129) capable of determining an amount of ambient light present at interior of vehicle (10) to thereby automatically adjust light output from light (128).

As best shown in FIG. 6, lower frame (114) includes an upper port (140) and a lower port (142) with fan (130) inside of cavity (141) therebetween. Fan (130) is capable of moving air in a first airflow direction from upper port (140) to lower port (142) and in a second airflow direction from lower port (142) to upper port (140) based on which direction fan (130) rotates. As can be seen, upper port (140) and lower port (142) are in direct gaseous communication with opening (108) such that air can be pulled and pushed into and out of opening (108) by fan (130) in a direction parallel to opening axis (109). Lower frame (114) defines an airfoil (144) (also referred to as a partition) positioned between fan (130) and opening (108) and between upper port (140) and lower port (142). Airfoil (144) or other geometries of lower frame (114) can be operable and geometrically optimized to drive air in either direction through opening (108) via the Coanda effect when fan (130) is driving air between upper port (140) and lower port (142). Typical operation of fan assembly (100) for active ventilation would include lid (190) being in an open position, however, fan assembly (100) can also operate with lid (190) closed and provide recirculation within vehicle (10). Lower frame (114) also defines a cable channel (146) for guiding electrical cables from processor (124) to each motor (120), lights (127, 128), sensors (129), and switches (125, 126).

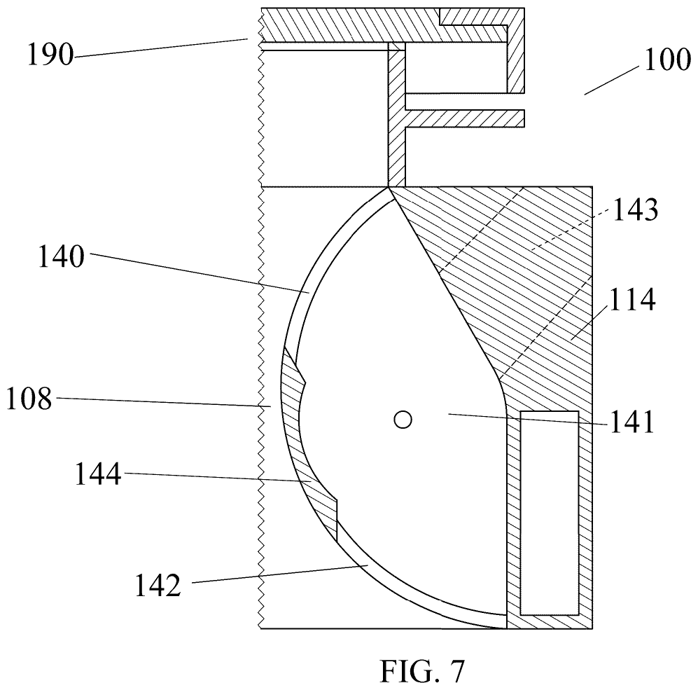

FIG. 7 shows a close up of the right side of FIG. 6, less fan (130). Airfoil (144) includes an outer curved surface which faces opening (108). In certain situations, a user may want to move air between outside of vehicle (10) and interior of vehicle (10) while lid (190) is in the closed position. Lower frame (114) may include a direct port (143) instead of or in addition to upper port (140). Direct port (143) may be in gaseous communication directly with air outside of vehicle (10) rather than such gas passing into opening (108). In such an embodiment, direct port (143) may be aligned with an adjacent opening of roof (12) to thus allow such air to pass through roof (12) rather than opening (108).

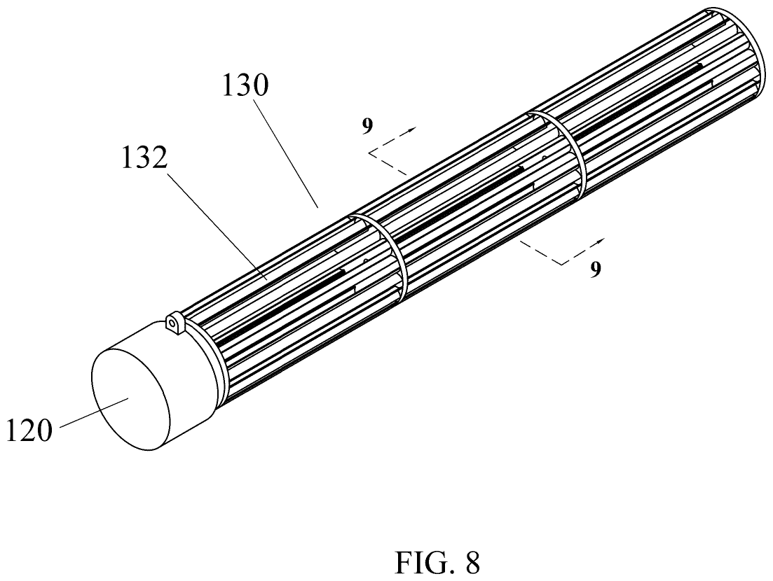

FIG. 8 shows motor (120) and attached fan (130). Motor (120) is operable to rotate fan (130) to thus induce airflow through opening (108). Motor (120) includes a D-shaped male shaft (not shown) operable to engage fan (130) having a D-shaped female opening (not shown). Motor (120) vertically supports an end of fan (130) closest to motor (120). Motor cover (122) may support the opposing end of fan (130) such that when motor cover (122) is removed, fan (130) is slidable away from motor (120) for cleaning and inspection. Reassembly is the reverse where fan (130) is slidably coupled to motor (120) via the D-shaped male shaft. Alternatively or additionally, the opposing end of fan (130) may be supported by lower frame (114) and removal of motor (120) may be performed prior to removal of fan (130), with reassembly being the reverse process. The D-shaped fitment is non-limiting and such fitment may be anything reasonably foreseeable to one skilled in the art where a slidable or alternatively feasible engagement between motor (120) and fan (130) is possible.

Fan (130) is a linear fan operable to flow air given either a clockwise or counterclockwise rotational direction. Alternatively, fan (130) may be unidirectional such that it is best configured to flow air in a single direction and thus optimized to be subject to a particular rotational direction. Braces may be positioned longitudinally along fan (130) to thus support each blade (132) of fan (130).

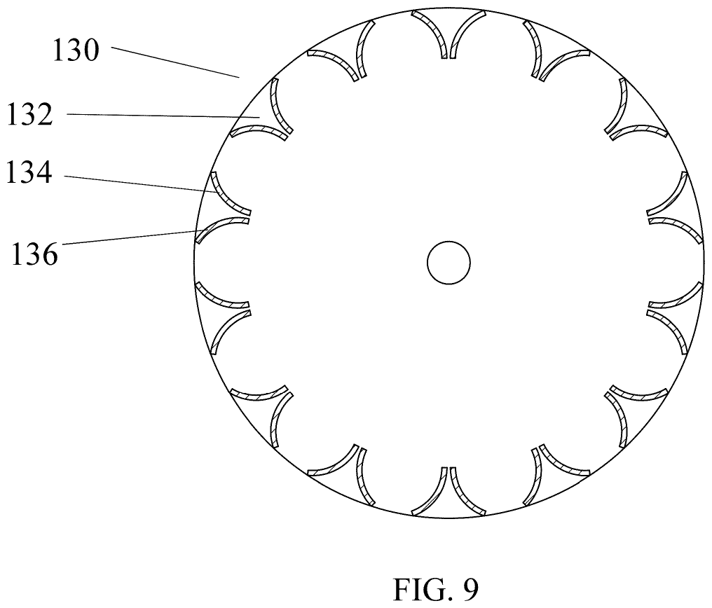

FIG. 9 shows blades (132) of fan (130) each including a first direction portion (136) and a second direction portion (134). As shown, fan (130) is a bidirectional fan (130) but, optionally, either first direction portion (136) or second direction portion (134) may be omitted. Such omission makes fan (130) unidirectional. Alternative blade (132) geometries and lay outs are possible. For example, blades may not need to alternate between a first direction portion (136) then a second direction portion (134). Optional alternative configurations such as a the pattern of two consecutive first direction portions (136) followed by two consecutive second direction portions (134) may be possible.

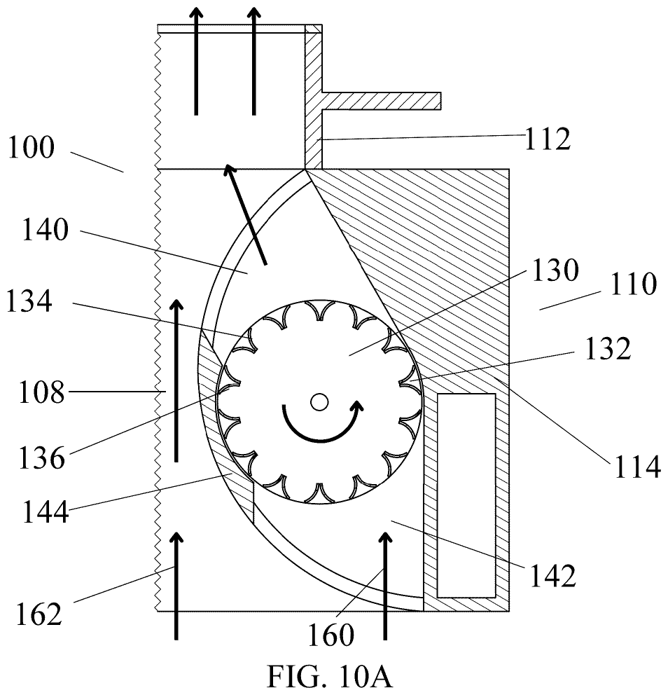

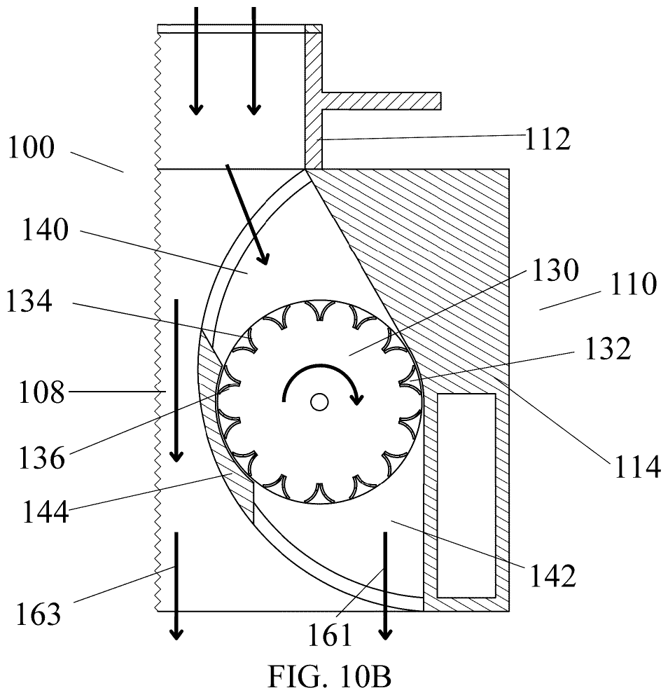

FIGS. 10A-10B shows fan assembly moving air from interior of vehicle (10) (FIG. 10A) and to interior of vehicle (10) (FIG. 10B). As shown in FIG. 10A, a counter-clockwise direction of fan (130) yields a fan airflow (160) via first direction portion (136) from interior of vehicle (10), through lower port (142), past upper port (140) and outside vehicle (10). Such fan airflow (160) creates an area of low pressure at bottom of opening (108) which pulls air through opening (108) to create opening airflow (162). FIG. 10B illustrates clockwise rotation of fan (130) causing fan airflow (161) via second direction portion (134), causing opening airflow (163) in an opposite direction from opening airflow (162). As described above, fan (130) may be selectively operable to rotate in both the clockwise and counterclockwise directions. Airfoil (144) and surrounding geometries of lower frame (114) may be operable to magnify airflow through opening (108) in either direction by means of the Coanda effect as mentioned above.

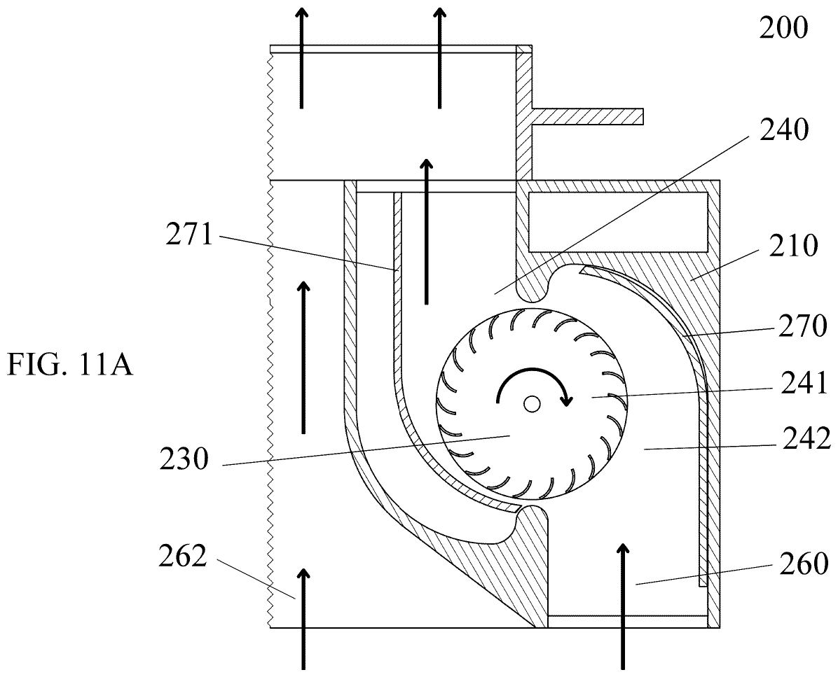

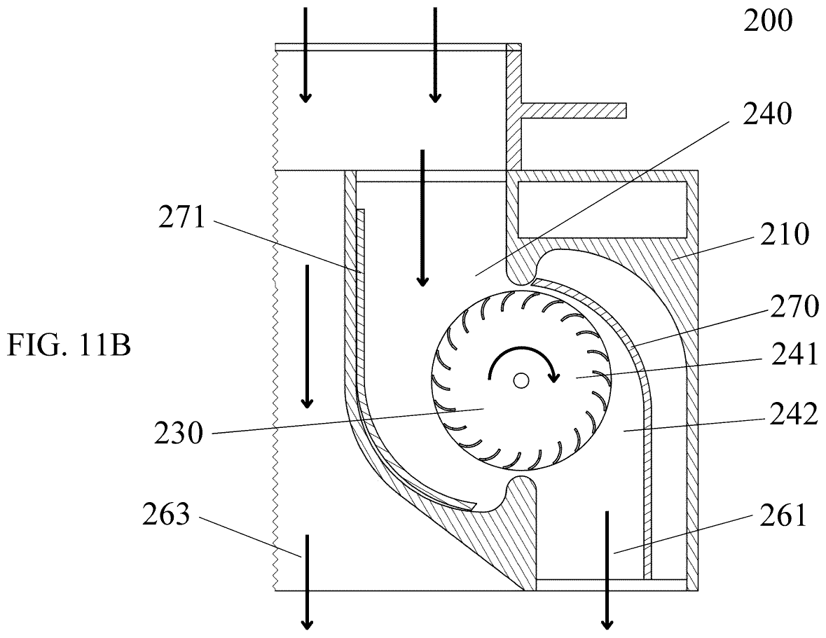

FIGS. 11A-11B show an alternative fan assembly (200). Fan assembly (200) may be substantially equivalent in form and function to fan assembly (100) but for the following differences. Fan assembly (200) depicts changing directions of fan airflow (260, 261) and thus opening airflow (262, 263) may be accomplished by moving frame (210) components (270, 271) which alter geometries of upper port (240), cavity (241), and lower port (242) rather than changing fan (230) rotation direction. In such an instance, a unidirectional fan (230) may be provided while still allowing a user to selectively control the airflow direction. Alternatively, while not shown, an axial fan(s) or any other air moving mechanism in cavity (241) may accomplish fan airflow (260, 261) and thus opening airflow (262, 263). As shown, components (270, 271) may act as baffles to redirect airflow around fan (230). Accordingly, components (270, 271) are moveable relative to frame (210) based on a desired direction of airflow through ports (240, 242). FIGS. 10A-10B and 11A-11B show opening airflow (162, 163, 262, 263), however, fan assembly (100, 200) may achieve fan airflow (160, 161, 260, 261) without opening airflow (162, 163, 262, 263).

### II. Examples of Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

An apparatus, comprising: (a) a frame surrounding an opening, the frame including: (i) a cavity, (ii) an upper port fluidly connecting the cavity to the opening, and (iii) a lower port fluidly connecting the cavity to the opening; (b) a lid operatively connected to the frame and configured to selectively move from a closed position toward an open position, wherein the lid in the closed position covers the opening, and wherein the lid in the open position allows an airflow through the opening; and (c) a first fan positioned within the cavity and configured to direct the airflow between the upper port and the lower port for venting the airflow.

### Example 2

The apparatus of Example 1, wherein the first fan includes a blade, and wherein the blade is not positioned within the opening.

### Example 3

The apparatus of any one or more of Examples 1 through 2, further comprising a vehicle including a vehicle body, wherein the frame is received within the vehicle body.

### Example 4

The apparatus of any one or more of Examples 1 through 3, wherein the first fan is positioned between the upper port and the lower port, wherein the first fan is configured to drive the airflow between the upper port and the lower port to thereby initiate the airflow being driven through the opening.

### Example 5

The apparatus of any one or more of Examples 1 through 4, wherein one of the following is true: wherein the first fan is bidirectional such that the first fan includes a first direction portion configured to drive the airflow from the lower port to the upper port upon a first rotation direction of the first fan and such that the first fan includes a second direction portion configured to drive the airflow from the upper port to the lower port upon a second rotation direction of the first fan, wherein the first rotation direction and the second rotation direction are different; and the frame includes baffles configured to reverse a direction of airflow between the upper port and the lower port, and the first fan is unidirectional.

### Example 6

The apparatus of any one or more of Examples 1 through 5, wherein the first fan includes a linear fan blade.

### Example 7

The apparatus of any one or more of Examples 1 through 6, further comprising a second fan positioned within the frame and operatively coupled to at least one motor.

### Example 8

The apparatus of Example 7, wherein the opening is positioned between the first fan and the second fan.

### Example 9

The apparatus of any one or more of Examples 1 through 8, wherein the frame includes a partition adjacent to the opening, wherein the partition is configured to drive the airflow through the opening via a Coanda effect.

### Example 10

The apparatus of any one or more of Examples 1 through 9, wherein the frame includes an upper frame portion and a lower frame portion, wherein the upper frame portion and the lower frame portion each include a respective surface configured to sandwich at least a portion of a mount wall therebetween for mounting the frame to the mount wall.

### Example 11

The apparatus of any one or more of Examples 1 through 10, wherein the lid is translucent or transparent and for allowing light to pass through the lid and into the opening when in the closed position.

### Example 12

The apparatus of any one or more of Examples 1 through 11, further comprising a second fan, wherein each of the first fan and the second fan are unidirectional and configured to drive the airflow in a respective first direction more efficiently than in a respective second direction, wherein the first direction and the second direction are opposite.

### Example 13

The apparatus of Example 12, wherein the first direction of the first fan is in an opposite direction of the second direction of the second fan such that the first fan and the second fan are configured to drive the airflow through the opening in opposing directions.

### Example 14

The apparatus of Example 13, further comprising a switch operatively connected to each of the first and second fans and configured to selectively energize either the first fan or the second fan and to simultaneously not energize the other of the first fan or the second fan.

### Example 15

The apparatus of any one or more of Examples 1 through 14, further comprising a light source connected to the frame, and wherein the light source is configured to direct light away from the frame.

### Example 16

An apparatus, comprising: (a) a frame including a partition and defining an opening adjacent to the partition, wherein the frame is configured to mount to a surface panel; (b) at least one motor; (c) a first fan positioned within the frame and operatively coupled to the at least one motor to thereby be driven by the at least one motor, wherein the partition is positioned between the opening and the first fan, wherein the first fan is configured to drive an airflow through the opening and around the partition via the first fan such that the partition is between the driven airflow and the first fan; and (d) a lid sized to selectively cover the opening.

### Example 17

The apparatus of Example 16, wherein the frame includes an upper port and a lower port, wherein the first fan is positioned between the upper port and the lower port, wherein the first fan is configured to drive the airflow between the upper port and the lower port to thereby drive the airflow around the partition.

### Example 18

The apparatus of any one or more of Examples 16 through 17, wherein one of the following is true: wherein the first fan is bidirectional such that the first fan includes a first direction portion configured to drive the airflow from the lower port to the upper port upon a first rotation direction of the first fan and such that the first fan includes a second direction portion configured to drive the airflow from the upper port to the lower port upon a second rotation direction of the first fan, wherein the first rotation direction and the second rotation direction are different, and the frame includes baffles configured to reverse a direction of airflow between the upper port and the lower port, and the first fan is unidirectional.

### Example 19

A method of incorporating a vent fan with a vehicle, the vent fan including (a) a frame surrounding an opening, the frame including: (i) a cavity, (ii) a upper port fluidly connecting the cavity to the opening, and (iii) a lower port fluidly connecting the cavity to the opening; (b) a lid operatively connected to the frame and configured to selectively move from a closed position toward an open position, wherein the lid in the closed position covers the opening, and wherein the lid in the open position allows an airflow through the opening; and (b) a first fan positioned within the cavity and configured to direct the airflow between the upper port and the lower port for venting the airflow, the method comprising: (a) mounting the vent fan to a vehicle body of the vehicle thereby incorporating the vent fan into the vehicle.

### Example 20

The method of Example 19, further comprising venting the vehicle via the vent fan.

### III. Miscellaneous

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those skilled in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one skilled in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. An apparatus, comprising:
(a) a frame surrounding an opening, the frame including:
(i) a cavity,
(ii) an upper port fluidly connecting the cavity to the opening, and
(iii) a lower port fluidly connecting the cavity to the opening;
(b) a lid operatively connected to the frame and configured to selectively move from a closed position toward an open position, wherein the lid in the closed position covers the opening, and wherein the lid in the open position allows an airflow through the opening; and
(c) a first fan positioned within the cavity and configured to direct the airflow between the upper port and the lower port for venting the airflow.

2. The apparatus of claim 1, wherein the first fan includes a blade, and wherein the blade is not positioned within the opening.

3. The apparatus of claim 1, further comprising a vehicle including a vehicle body, wherein the frame is received within the vehicle body.

4. The apparatus of claim 1, wherein the first fan is positioned between the upper port and the lower port, wherein the first fan is configured to drive the airflow between the upper port and the lower port to thereby initiate the airflow being driven through the opening.

5. The apparatus of claim 1, wherein one of the following is true:
(a) wherein the first fan is bidirectional such that the first fan includes a first direction portion configured to drive the airflow from the lower port to the upper port upon a first rotation direction of the first fan and such that the first fan includes a second direction portion configured to drive the airflow from the upper port to the lower port upon a second rotation direction of the first fan, wherein the first rotation direction and the second rotation direction are different; and
(b) the frame includes baffles configured to reverse a direction of airflow between the upper port and the lower port, and the first fan is unidirectional.

6. The apparatus of claim 1, wherein the first fan includes a linear fan blade.

7. The apparatus of claim 1, further comprising a second fan positioned within the frame and operatively coupled to at least one motor.

8. The apparatus of claim 7, wherein the opening is positioned between the first fan and the second fan.

9. The apparatus of claim 1, wherein the frame includes a partition adjacent to the opening, wherein the partition is configured to drive the airflow through the opening via a Coanda effect.

10. The apparatus of claim 1, wherein the frame includes an upper frame portion and a lower frame portion, wherein the upper frame portion and the lower frame portion each include a respective surface configured to sandwich at least a portion of a mount wall therebetween for mounting the frame to the mount wall.

11. The apparatus of claim 1, wherein the lid is translucent or transparent and for allowing light to pass through the lid and into the opening when in the closed position.

12. The apparatus of claim 1, further comprising a second fan, wherein each of the first fan and the second fan are unidirectional and configured to drive the airflow in a respective first direction more efficiently than in a respective second direction, wherein the first direction and the second direction are opposite.

13. The apparatus of claim 12, wherein the first direction of the first fan is in an opposite direction of the second direction of the second fan such that the first fan and the second fan are configured to drive the airflow through the opening in opposing directions.

14. The apparatus of claim 13, further comprising a switch operatively connected to each of the first and second fans and configured to selectively energize either the first fan or the second fan and to simultaneously not energize the other of the first fan or the second fan.

15. The apparatus of claim 1, further comprising a light source connected to the frame, and wherein the light source is configured to direct light away from the frame.

16. An apparatus, comprising:
(a) a frame including a partition and defining an opening adjacent to the partition, wherein the frame is configured to mount to a surface panel;
(b) at least one motor;
(c) a first fan positioned within the frame and operatively coupled to the at least one motor to thereby be driven by the at least one motor, wherein the partition is positioned between the opening and the first fan, wherein the first fan is configured to drive an airflow through the opening and around the partition via the first fan such that the partition is between the driven airflow and the first fan; and
(d) a lid sized to selectively cover the opening.

17. The apparatus of claim 16, wherein the frame includes an upper port and a lower port, wherein the first fan is positioned between the upper port and the lower port, wherein the first fan is configured to drive the airflow between the upper port and the lower port to thereby drive the airflow around the partition.

18. The apparatus of claim 17, wherein one of the following is true:
(a) wherein the first fan is bidirectional such that the first fan includes a first direction portion configured to drive the airflow from the lower port to the upper port upon a first rotation direction of the first fan and such that the first fan includes a second direction portion configured to drive the airflow from the upper port to the lower port upon a second rotation direction of the first fan, wherein the first rotation direction and the second rotation direction are different, and
(b) the frame includes baffles configured to reverse a direction of airflow between the upper port and the lower port, and the first fan is unidirectional.

19. A method of incorporating a vent fan with a vehicle, the vent fan including (a) a frame surrounding an opening, the frame including: (i) a cavity, (ii) a upper port fluidly connecting the cavity to the opening, and (iii) a lower port fluidly connecting the cavity to the opening; (b) a lid operatively connected to the frame and configured to selectively move from a closed position toward an open position, wherein the lid in the closed position covers the opening, and wherein the lid in the open position allows an airflow through the opening; and (b) a first fan positioned within the cavity and configured to direct the airflow between the upper port and the lower port for venting the airflow, the method comprising:
(a) mounting the vent fan to a vehicle body of the vehicle thereby incorporating the vent fan into the vehicle.

20. The method of claim 19, further comprising venting the vehicle via the vent fan.
